(19) United States
(12) Patent Application Publication
(10) Pub. No.: US 2021/0103940 A1
(43) Pub. Date: Apr. 8, 2021

(54) Data-Driven Operating Model (DDOM) System

(71) Applicant: Adobe Inc., San Jose, CA (US)

(72) Inventors: Robert Keith Giglio, Moraga, CA (US); Mark Andrew Picone, Naples, FL (US); Maninder Singh Sawhney, San Jose, CA (US); Eric L. Cox, Los Gatos, CA (US); Ashley Elizabeth Wells, San Francisco, CA (US); Nicholas James Woo, San Jose, CA (US); Vineet Bhalla, Sunnyvale, CA (US); Brandon John Tatton, Pleasant Grove, UT (US); Amit Sethi, Foster City, CA (US); Simmi Kochhar Bhargava, Cupertino, CA (US); Ryan John Stansfield, Danville, CA (US); Sharad Narang, New Delhi (IN); Samarpan Das, Bangalore (IN); Krishna Kishore Veturi, San Jose, CA (US); Jagadeswarareddi Vaka, San Jose, CA (US); Brian Daniel Block, Saratoga, CA (US); Purnaram Kodavatiganti, Dublin, CA (US); Thomason Nguyen, Sunnyvale, CA (US); Dhrumil Bharat Joshi, Santa Clara, CA (US); Amarendra Reddy Duvvuru, Dublin, CA (US); Ashfaq Mohiuddin, Orinda, CA (US); Sumesh Kumar, Palo Alto, CA (US)

(73) Assignee: Adobe Inc., San Jose, CA (US)

(21) Appl. No.: 16/687,182

(22) Filed: Nov. 18, 2019

(30) Foreign Application Priority Data
Oct. 5, 2019 (IN) 201911040470

(51) Int. Cl. G06Q 30/02; G06Q 40/00; G06N 20/00; G06F 11/34; G06F 9/451

(52) U.S. Cl. CPC G06Q 30/0201; G06Q 40/12; G06F 9/451; G06F 11/3409; G06N 20/00

(57) ABSTRACT

Data-driven operating model (DDOM) systems and techniques are described to manage implementation, access, and promotion of digital services by a service provider system. In one example, the DDOM system includes a data aggregation module, a journey manager module and a segment manager module. The data aggregation module supports a unified data architecture that is then leverage by the journey and segment manager modules to support matrixed journey stage and segmentation of a data lake to provide insights that are not possible by a human being alone, that are usable to manage implementation, access, and promotion of digital services by a service provider system.

### BACKGROUND

Digital services include automated services that are delivered via a network to computing devices to support a wide variety of functionality through execution by the computing devices locally in whole or in part through execution in conjunction with a service provider system. Examples of this functionality include digital content creation services, (e.g., digital audio, digital video, eBooks, digital images, etc.), digital content streaming services, digital video game services, digital storage services, digital health services, webservices and websites, and so forth.

In one example, digital services are used to replace traditional “one off” software distribution techniques of distributing a single instance of software with a digital service that is maintained and updated remotely by a service provider system. A user, for instance, may purchase a subscription to digital services supported by a service provider system, and from this, access digital services that are maintained locally and updated remotely by the system. As part of this, a service provider system that implements the digital services may be tasked with supporting a variety of different digital services, each of which supports a multitude of functionality that is accessible by thousands and even millions of users. Therefore, service provider systems are now tasked with managing operation of computing devices as part of the implementation of the digital services as well as how access is provided and promoted to users and potential users of the digital services. Conventional techniques and systems, however, fail to efficiently do so when confronted with the multitude of data generated by these services, e.g., petabytes of data from a wide range of disparate systems.

### SUMMARY

Data-driven operating model (DDOM) systems and techniques are described to manage implementation, access, and promotion of digital services by a service provider system. In one example, the service provider system is configured to manage operation of computing devices that implement the digital services, expose data describing user interaction with the services, forecast future user interaction, and generate recommendations regarding the user interaction through use of a DDOM system.

The DDOM system, for instance, may be designed to derive actionable insights across a diverse range of customer journeys from 1) a data foundation layer, a data lake aggregated by a data aggregation module from a diverse range of data sources, and 2) a key performance indicator (KPI) generation module, built as a layer on top of the data foundation to expose metrics regarding achievement of goals of each of a plurality of journey stages (i.e., journey stage completion) implemented by a journey manager module.

In this way, the journey manager module is configured to oversee generation of the KPIs, KPI forecasts, and recommendations regarding a subset of user interactions described as a “journey stage” (stages of the end-to-end customer journey) with respect to the digital services. A segment manager module is also implemented by the DDOM system to manage segments of the user interaction, e.g., by user segment, geography, customer device type, product line, and so on. In this way, the modules support matrixed journey stage and segment views of a data lake to provide insights that are not possible by a human being alone, that are usable to manage implementation, access, and promotion of digital services by a service provider system.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ data-driven operating model (DDOM) techniques and systems described herein.

FIG. 2 depicts an example implementation showing operation of a data aggregation module of FIG. 1 in greater detail as generating a data lake.

FIG. 3 depicts matrixed journey stage and segmentation of a data lake of FIG. 2 by a DDOM system of FIG. 1.

FIG. 4 depicts a system in an example implementation showing journey stage manager modules of the DDOM system as implementing discover, try, buy, use, and renew stages of FIG. 3.

FIG. 5 depicts a system showing operation of a discover stage manager module of FIG. 4 in greater detail.

FIG. 6 depicts a system showing operation of a try stage manager module of FIG. 4 in greater detail.

FIG. 7 depicts a system showing operation of a buy stage manager module of FIG. 4 in greater detail.

FIG. 8 depicts a system showing operation of a use stage manager module of FIG. 4 in greater detail.

FIG. 9 depicts a system showing operation of a renew stage manager module of FIG. 4 in greater detail.

FIG. 10 depicts an example of a user interface as an “RTB” dashboard for executives and marketers.

FIG. 11 depicts an example of a user interface as a “practitioner cube” dashboard for analysts and data scientists.

FIG. 12 depicts a system showing operation of a segment manager module of FIG. 3 in greater detail.

FIG. 13 is a flow diagram depicting a procedure in an example implementation of a DDOM system of FIG. 1.

FIG. 14 illustrates an example system including various components of an example device that can be implemented as any type of computing device as described and/or utilize with reference to FIGS. 1-13 to implement embodiments of the techniques described herein.

### DETAILED DESCRIPTION

### Overview

Conventional techniques used to manage access by service provider systems to digital services are confronted by a multitude of diverse types of data that may be generated to describe the interaction and operation of the digital services. Consequently, conventional systems relied on a “best guess” on how to provision computational and network resources used to implement the digital services, how to manage access by millions of user devices to the digital services, how to sell and retain subscriptions, and so forth due to an inability to identify, prioritize and elevate actionable insights from this vast amount of data.

Accordingly, data-driven operating model (DDOM) systems and techniques are described to manage implementation, access, and promotion of digital services by a service provider system. In one example, the DDOM system is configured to manage operation of computing devices that implement the digital services, expose data describing user interaction with the services, forecast future user interaction, and generate recommendations regarding the user interaction.

As part of designing the DDOM system, user interaction with digital services of the DDOM system is modeled as a customer journey for implementation by a journey manager module. The journey, for instance, may be described by the DDOM system using a series of stages as sequential and non-overlapping portions of data describing user engagement with the digital services of the service provider system. In examples described herein, the user engagement is modeled by the DDOM system as part of obtaining and maintaining a subscription to access the digital services of the service provider system. Therefore, each of the stages is defined as data pertaining to an interval in a series of intervals between journey steps as part of getting, using, and maintaining a subscription to access digital services of the service provider system in this example. Other examples are also contemplated, e.g., involving user interaction having journey stages 1, 2, 3, . . . X, each stage involving user interaction with other digital services such as streaming digital services.

Once the stages of the journey are modeled, the DDOM system is configured to generate key performance indicators (KPIs) using a KPI generation module for the individual stages of the journey, i.e., the portions of the data pertaining to the particular stages of the journey. The key performance indicators, for instance, may be output in real time in a user interface (e.g., a “dashboard”) as metrics that describe the user interaction at the individual stages.

Key performance indicators are a quantifiable measure that are usable to evaluate achieving a performance objective, which in this instance is tied to defined journey stage user interactions which result in the completion for each stage. In this way, data may be portioned for each of the stages of the journey. For instance, for a “Buy” stage which evaluates user purchasing interactions, the journey stage completion may be defined as when conversion to a paid subscription has been achieved. Accordingly, key performance indicators generated for data pertaining to the journey stage are used to provide insight, in real time, in a user interface toward achieving this goal. The KPIs, for instance, may be used to describe how this conversion was achieved, which is not possible for a human to perform based on the amount of data involved, especially in real time.

To support generation of the KPIs, the DDOM system is configured to aggregate data by a data aggregation module from a variety of different sources that describe a variety of different aspects of user interaction with the service provider system. This data may include user profile data, financial data, clickstream data, product usage data, entitlement data, target data, and so forth. The data, for instance, may describe interaction with a variety of digital content creation services used to create, modify, and manage digital content, e.g., digital images, digital video, digital audio, and so forth. This may also include data collected from “outside” the service provider, e.g., analytical data collected via “smart pixels” embedded as part of webpages.

As part of this, data may be transformed, portioned, and stored in a “data lake” (e.g., data maintained in a collection of storage devices) in a form that is readily comparable with other data present in the data lake. The data lake serves as a unified data architecture as a single source of truth of data from the various sources. The data aggregation module, for instance, may support online analytics processing (OLAP) to answer multi-dimensional analytic (DA) queries through use of analytical databases and data mining This supports user interaction without requiring sophisticated programming knowledge to generate queries as a custom pivot table across a vast amount of data. In this way, data may be obtained from a wide variety of sources that describe user interaction with the digital services, wherein the data lake acts as a “single source of truth” to support unified metrics across a wide range of different types of data. This allows data of the data lake to be “sliced” to support portioning between the journey stages and segments and generation of respective KPIs for those stages and/or segments. This also may be performed in real time as the data is generated through interaction with the digital services, and as such the data lake represents a “current” view of this user interaction with the digital services, which as previously described may include a vast amount of data (e.g., tens of terabytes, petabytes) that is not readily addressable by a human on their own especially when confronted with the wide range and different types this data may assume.

As a result, the DDOM system may be designed to address a diverse range of journeys using a variety of actionable insights in which the data lake aggregated by the data aggregation module is a foundational layer supporting a unified data architecture. The KPI generation module is built as a layer on top of the data lake to expose metrics regarding achievement of goals for each of the stages (i.e., journey stage completion) by a journey manager module. Therefore, in operation, once the data is aggregated, the data is made accessible to the journey manager module of the DDOM system. The journey manager module is configured to support generation of the key performance indicators, forecasts, and recommendations regarding user interaction described as a “journey” with respect to the digital services.

In one example, the journey is modeled using discover, try, buy, use, and renew stages and data is portioned as pertaining to those stages. The discover stage is defined based on user identifiers (IDs) that are exploring or considering the digital services: examples include user IDs that have signed up but have not downloaded free or paid software supporting a digital service, currently paid users who are exploring additional free or paid offerings, or user IDs that have subscribed but have cancelled within a threshold amount of time (e.g. more or less than 30 days) Journey stage completion of the discover stage is an event defined for when the user ID has migrated from expressing interest to expressing intent (e.g. has signed up has signed up to access the digital services including part of free signup, has downloaded a free app or trial product, or directly purchased a product or offering).

The try stage defines a portion of the data lake describing user interaction of user IDs that have downloaded software as part of interaction with the digital services but are not currently paid subscribers. This includes trial user IDs that are within a finite trial time period that are entitled to access a digital service and other free user IDs in one example. Journey stage completion of the try stage is an event defined based on purchase of access to the digital service, e.g., a subscription.

The buy stage defines a portion of the data lake describing user interaction of user IDs as part of “converting” to pay for access to the digital services. Journey stage completion of the buy stage is an event defined based on reaching conversion.

The use stage includes user IDs that currently pay for access to the digital services, e.g., are “converted” and thus describe how a user becomes activated and engages with the digital services. Journey stage completion of the use stage is an event defined based on reaching an end of a term (e.g., subscription term) or cancelling a right to gain access.

A renew stage follows that defines a portion of the data lake including user IDs that have cancelled paid for access, have reached an end of term, and so forth. Journey stage completion of the renew stage is an event defined based on retaining user IDs, e.g., user IDs that have transitioned back to one of the other journey stages such as discover, try, buy, or use stages.

Thus, the stages of the journey manager module of the DDOM system support an ability to gain insight into user interaction with digital services of the service provider system and how to address those interactions that is not possible to be performed by a human, especially in real time when confronted with the vast amount of data. As part of this, the journey manager module generates key performance indicators for output via a user interface (i.e., a “dashboard”) in real time as metrics to provide this insight. The key performance indicators may be the same and/or differ across the stages and associated UIs as further described in the following sections.

The DDOM system also includes a segment manager module that is configured to support a user interface that displays segment level portions of the data lake across the stages of the journey. User segmentation, for instance, describes a portion of a user population having shared characteristics—e.g. geography segment, product/offering segment, customer type segment, or surface segment (e.g., mobile versus desktop). A surface segment, for instance, may be defined for a segment of the data lake that initiates contact with the digital services through use of free mobile applications and progresses to paid subscription across the journey stages.

The segment manager module may therefore support output of a user interface (i.e., dashboard) in real time including KPIs that describes a portion of the data lake of the unified data architecture that corresponds to the mobile segment across the stages as a whole, at individual stages, and so on. In this way, the journey manager module and segment manager module together support matrixed journey stage and segment views of the data lake to provide insights usable to manage implementation, access, and promotion of digital services by a service provider system.

KPIs output by the user interfaces, for instance, may be used to provision computational and network resources of the service provider system to respond to user interaction with the digital services. The KPIs may also be used to provision resources involving communication of digital content and offers by the DDOM system to the users, such as to communicate digital marketing content, free mobile applications, and so on. Further discussion of these and other examples is included in the following sections and shown in corresponding figures.

In the following discussion, an example environment is described that may employ the techniques described herein. Example procedures are also described which may be performed in the example environment as well as other environments. Consequently, performance of the example procedures is not limited to the example environment and the example environment is not limited to performance of the example procedures.

### Example Environment

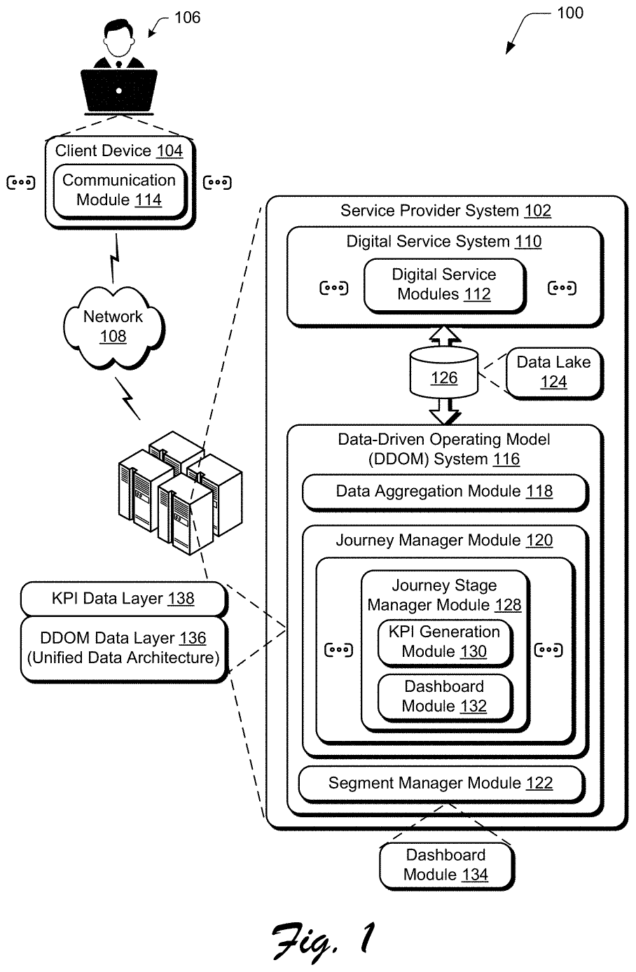

FIG. 1 is an illustration of a digital medium environment 100 in an example implementation that is operable to employ data-driven operating model (DDOM) techniques described herein. The illustrated environment 100 includes a service provider system 102 and a client device 104 (illustrated as supporting user interaction with a user 106) of plurality of client devices that are communicatively coupled to the service provider system via a network 108. Computing devices that implement the service provider system 102 and the client device 104 may be configured in a variety of ways.

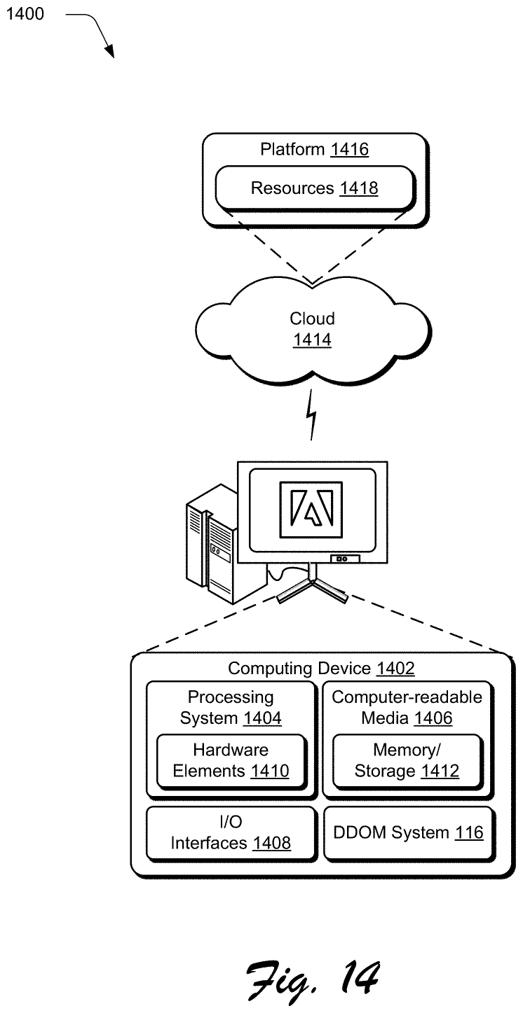

A computing device, for instance, may be configured as a desktop computer, a laptop computer, a mobile device (e.g., assuming a handheld configuration such as a tablet or mobile phone), a server, and so forth. Thus, a computing device may range from full resource devices with substantial memory and processor resources (e.g., personal computers, game consoles) to a low-resource device with limited memory and/or processing resources (e.g., mobile devices). Additionally, a computing device may be representative of a plurality of different devices, such as multiple servers utilized by a business to perform operations “over the cloud” as illustrated for the service provider system 102 and further described in relation to FIG. 14.

The digital service system 110 includes a plurality of digital service modules 112 that are executable by a processing system and computer-readable storage medium to implement respective ones of a plurality of digital services that are accessible to a communication module 114 of the client device 104 via the network 108. As previously described, digital services include automated services that are delivered via a network to computing devices to support a wide variety of functionality through execution by the computing devices, locally in whole or in part through execution in conjunction with the service provider system 102.

A user 106 of client device 104, for instance, may interact with the communication module 114 (e.g., a browser, network-enabled application) to download and execute digital service modules 112 locally at the client device 104, access this functionality through remote execution by the service provider system 102 via the network 108, and so forth. Examples of this functionality include digital content creation services, (e.g., digital audio, digital video, eBooks, digital images, etc.), digital content streaming services, digital video game services, digital storage services, digital health services, webservices and websites, and so forth.

In the digital content creation example, for instance, digital services may include image editing and compositing; editing, organizing, and storage of digital images, vector graphics, and illustration creation; page design and layout for digital publishing; user experience design and sharing; digital video creation and sharing; digital video and film editing; cinematic visual effects and motion graphics; image creation for branding, product, and package design; website design and development; animation generation; audio recording, mixing, and restoration; desktop-focused photo editing; two-dimensional character animation; media encoders; 3D character creation; metadata ingestion, logging, and rough cuts; and so forth. Thus, even a single type of digital service (such as digital content creation above) may include a variety of digital service modules 112 each of which supporting thousands of operations that are maintained to implement this functionality for access by millions of client devices 104. As part of this, the service provider system 102 may be tasked with maintaining a variety of information regarding user profiles, operations data involving use of computational and network resources used to implement the services, and so forth.

Accordingly, the service provider system 102 employs a DDOM system 116 to control implementation, operation, management, and dissemination of the digital services implemented by the digital service modules 112 of the digital service system 110. To do so, the DDOM system 116 includes a data aggregation module 118, a journey manager module 120, and a segment manager module 122.

The data aggregation module 118 is configured to generate a data lake 124 maintained in a storage device 126 from a diverse range of data sources. The data lake 124 is then leveraged by a journey manager module 120 and the segment manager module 122 to support a “matrixed” view regarding a journey of user IDs across stages of user interaction with the digital service and also interaction of segments of the user population, e.g., across the stages as a whole and/or individually at each stage.

To do so, the journey manager module 120 includes a journey stage manager module 128 that includes a KPI generation module 130 and a dashboard module 132 for each stage of the journey. The journey, for instance, may be described using a series of stages as sequential and non-overlapping portions of user engagement as part of obtaining and maintaining a subscription to access the digital services of the digital service modules 112 of the service provider system 102. The stages are defined as a series of intervals between journey steps as part of getting, using, and maintaining a subscription to access digital services.

As a result, the DDOM system 116 may be designed to address a diverse range of journeys using a variety of actionable insights in which the data lake 124 aggregated by the data aggregation module 118 is a foundational layer as represented by a DDOM data layer 134. The KPI generation module 130 is built as a layer on top of the data lake 124 to expose metrics regarding achievement of goals as represented by the KPI data layer 138. The journey manager module 120 implements an operational model on top of the KPI data layer 138 to define the goals of the KPIs, e.g., journey stage completion for each of the stages. In this way, the DDOM system 116 provides insights regarding user interaction with the digital services that may also include additional information regarding user interaction that is also performed “outside” the service provider system 102, e.g., through use of analytics data. The data lake 124 is then leveraged to generate KPIs to describe user interaction as a matrixed journey stage and segmentation as further described in the following section.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

### Data Lake Generation

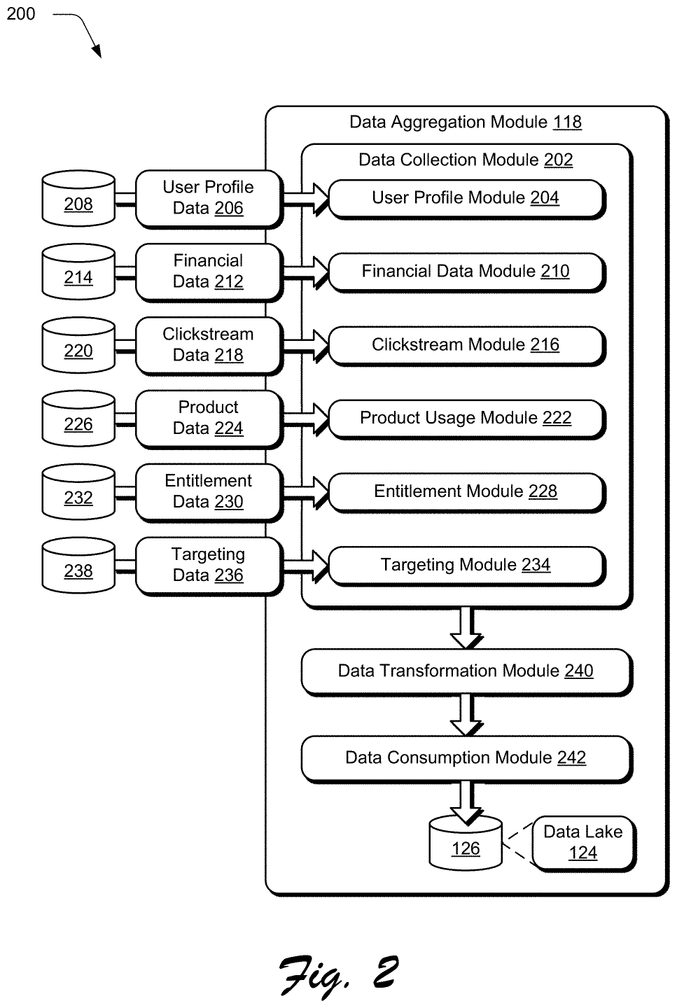

FIG. 2 depicts a system 200 in an example implementation showing operation of the data aggregation module 118 to generate the data lake 124 to implement a DDOM data layer 136 as a unified data architecture. The data aggregation module 118 is configured to collect data from a variety of different sources to form a “data lake” 124 that is maintained in a storage device 126 to support the techniques described herein. The illustrated data aggregation module 118 includes a data collection module 202 having dedicated modules to obtain data regarding various aspects of user interaction with the digital services (including computational and network resource consumption used to support this interaction) as well as user interaction with other digital content via the network 108 and/or locally at the client device 104.

An example of this includes a user profile module 204 to collect user profile data 206 associated with user IDs from a source device 208, e.g., a data science platform. User profile data 206, for instance, may describe user demographics, client device 104 information including hardware, software, and/or network resources, and so on. A financial data module 210 is configured to collect financial data 212 from a source device 214, e.g., from an in-memory, column-oriented, analytical database management system such as SAP® HANA. The financial data 212, for instance, may involve rights purchased for access to the digital services. The financial data 212 may also pertain to costs regarding operation of computational and network resources used to implement the digital services.

Likewise, a clickstream module 216 may be used to collect clickstream data 218 from a source device 220. Clickstream data 218 may be obtained from an analytics service that collects data through use of embedded modules (e.g., “smart pixels”) that are embedded as part of digital content. The embedded modules generate the clickstream data 218 as describing user interaction with the digital content, such as mobile applications, webpages, social media sites, blogs, and so forth. Thus, clickstream data 218 describes a series of user interactions over time with digital content, which may occur over a single source of digital content (e.g., website) or linked to multiple sources. In one example, the clickstream data 218 references websites visited, individual pages of the websites, how long and/or when the visits occurred, an order of the visits, newsgroups and emails set, and so forth that may occur both in relation to the digital services of the service provider system 102 and “outside” the digital services as occurring with other service provider systems.

A product usage module 222 is configured to collect product data 224 from a source device 226 that describes usage of the digital services of the service provider system 102. This may include identifying which digital service modules 112 are downloaded, usage of the digital service modules 112 including which operations are initiated using the modules by the client device 104, usage of services related to the products (e.g., purchases from a stock database made within a digital content creation digital service), and so forth. An entitlement module 228 is configured to collect entitlement data 230 from a source device 232 that describes user interaction with the digital services that is entitled with the service provider system 102, e.g., as part of a subscription.

A targeting module 234 is configured to collect targeting data 236 from a storage device 238 that describes dissemination to and interaction with digital marketing content. The digital marketing content, for instance, may be disseminated and tracked in conjunction with the clickstream data 218, may describe digital marketing content that is exposed by the service provider system 102 directly to the client device 104, and so forth. In this way, the data collection module 202 may collect a variety of “raw data” from a diverse range of source devices.

A data transformation module 240 is then employed by the data aggregation module 118 to transform the raw data for consistency with each other. The data aggregation module 118, for instance, may associate user IDs with corresponding portions of the raw data as indicative of a source of the user interaction described by the raw data. Data obtained from the different source devices may then be aggregated together for corresponding user IDs using source resolution techniques, e.g., such that user profile data 206, financial data 212, and so on correspond to a single user ID. The data transformation module 240 is also configured to transform the data for consistency across conventions used to express the data, e.g., temporal units, monetary units, and so forth.

As part of transforming the data, the data transformation module 240 may also employ a data quality framework. The data qualify framework employs a confidence matrix to ensure that the data is property represented across the data lake 124, including how the data of the unified data architecture implemented by the data lake 124 is represented across stages and segments. The data quality framework, for instance, may employ a reconciliation technique that compares data in its original form and transformed form to ensure consistency both from beginning to end as well as at the individual journey stages/portions. Anomalies may be flagged and corrected by the data quality framework. In this way, the data lake 124 may be ensured to correctly act as a “single source of truth” through a unified data architecture that is then made accessible as described below.

The data, once transformed, is then output to a data consumption module 242 that is configured to increase accessibility of the data. In one example, this is performed using online analytics processing (OLAP) that supports answers multi-dimensional analytic (DA) queries through use of analytical databases and data mining The data consumption module 242, for instance, may generate and query OLAP “practitioner cubes” for pre-aggregation of data, a level of which is controllable through interaction with the model. The practitioner cubes, in one example, are “built on” the data lake 124, which is a collection of open-source software utilities that provide a software framework for distributed storage and processing using a MapReduce programming model. As previously described, the practitioner cubes support queries from users that do not have sophisticated programming skills to portion the unified data architecture implemented by the data lake 124.

In this way, data may be obtained by the data aggregation module 118 from a wide variety of sources to generate the data lake 124 that acts as a “single source of truth” to support unified metrics across a wide range of different types of data. This also may be performed in real time as the data is generated (e.g., through interaction with the digital services) and as such the data lake represents a “current” view of this user interaction with the services as well as user interaction tracked “outside” of the service provider system 102. The data lake 124, for instance, may be organized at least in part using user IDs that are assigned to portions of the data lake 124 based on a source of this interaction, e.g., by user 106. This may also include use of source resolution techniques, e.g., to assign multiple user IDs as corresponding to a same source to further improve efficiency and insight into the user interaction.

### Matrixed Journey Stage and Segmentation of DDOM System

Returning again to FIG. 1, the data lake 124 generated in the previous section is then leveraged by the journey manager module 120 and the segment manager module 122 to support a “matrixed” view regarding a journey of user IDs across stages of user interaction with the digital service and also interaction of segments of the user population, e.g., across the stages as a whole and/or individually at each stage. The DDOM data layer 136, for instance, acts as a foundational layer of a unified data architecture with KPIs of the KPI data layer 138 built “on top of that”. In this way, the DDOM system 116 leverages the unified data architecture to provide insights regarding user interaction with the digital services that may also include additional information regarding user interaction that is also performed “outside” the service provider system 102, e.g., through use of analytics data.

To do so, the journey manager module 120 includes a journey stage manager module 128 that includes a KPI generation module 130 and a dashboard module 132 for each stage of the journey. The journey, for instance, may be described using a series of stages as sequential and non-overlapping portions of user engagement as part of obtaining and maintaining a subscription to access the digital services of the digital service modules 112 of the service provider system 102. The stages are defined as a series of intervals between journey steps as part of getting, using, and maintaining a subscription to access digital services.

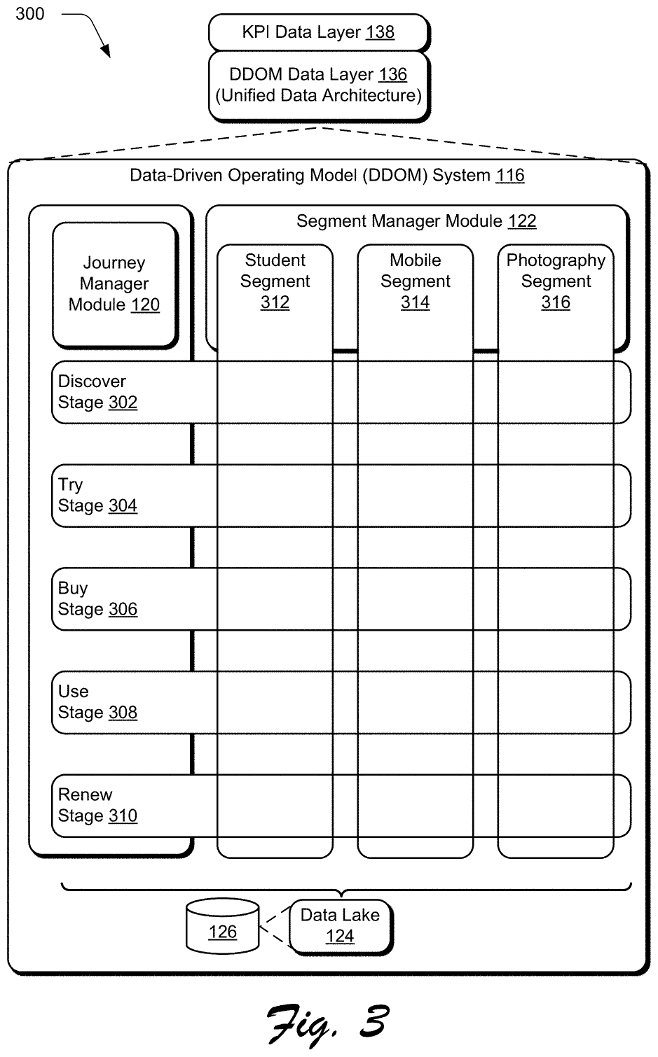

In an illustrated example 300 of FIG. 3, the journey is modeled by the journey manager module 120 using discover, try, buy, use, and renew stages 302, 304, 306, 308, 310. The discover stage 302 is defined based on user IDs in the data lake 124 that have yet to access or purchase the digital services, user IDs that have signed up but have not downloaded software supporting a digital service, lapsed traffic, and stopped traffic. The try stage 304 defines a portion of the data lake 124 describing user interaction of user IDs that have downloaded software as part of interaction with the digital services but are not currently paid subscribers.

The buy stage 306 defines a portion of the data lake 124 describing conversion of user IDs, e.g., are “signing up” to pay for access to the digital services. The use stage 308 defines a portion of the data lake 124 describing user interaction of user IDs that have purchased rights to access the digital services, e.g., have paid for a subscription as above. The renew stage 310 defines a portion of the data lake 124 including user IDs that have cancelled paid-for access rights, have reached an end of term, and so forth.

Thus, the stages supported by the journey manager module 120 of the DDOM system 116 support an ability to gain insight into user interaction with digital services of the service provider system 102 and how to address those interactions.

As part of this, each respective journey stage manager module 128 generates key performance indicators using respective KPI generation modules 130 for output via a user interface (i.e., a “dashboard”) by a respective dashboard module 132 in real time as metrics to provide this insight. The key performance indicators may be the same and/or differ across the stages and associated dashboards, i.e., UIs, as further described in the following section.

The DDOM system 116 also includes a segment manager module 122 that is configured to support output of user interfaces by a dashboard module 134 based on segments of portions of the data lake 124 across the stages of the journey. Segments, for instance, may be defined based on user type (e.g., student segment 312), a surface by which the digital services are accessed (e.g., mobile segment 314), type of digital services used (e.g., photography segment 316), and so forth.

User segmentation describes a portion of a user population having shared characteristics. Other segments include a surface segment, e.g., mobile versus desktop devices. A mobile segment, for instance, may be defined for a segment of the data lake that initiates contact with the digital services through use of free mobile applications and progresses to paid subscription across the journey stages. The segment manager module 122 may therefore support output of a user interface (i.e., dashboard) by the dashboard module 134 in real time including KPIs generated by the KPI generation module 130 that describes a portion of the data lake 124 that corresponds to the mobile segment across the stages as a whole, at individual stages, and so on.

In this way, the journey manager module 120 and the segment manager module 122 support matrixed journey stage and segmentation of the data lake 124 to provide insights usable to manage implementation, access, and promotion of digital services by a service provider system. KPIs output by the user interfaces, for instance, may be used to provision computational and network resources of the service provider system to respond to user interaction with the digital services. The KPIs may also be used to provision resources involving communication of digital content and offers by the DDOM system to the users, such as to communicate digital marketing content, free mobile applications, and so on. Further discussion of these and other examples is included in the following sections and shown in corresponding figures.

As previously described, the journey manager module 120 includes a plurality of journey stage manager modules 128, each of which is configured to address a stage with respect to a user journey involving interaction with digital services implemented by the service provider system 102. The journey, for instance, may be described using a series of stages as sequential portions (which may be non-overlapping) of user engagement as part of obtaining and maintaining a subscription to access the digital services of the service provider system 102. Each of the stages, therefore, is an interval of data in a series of intervals between journey steps as part of getting, using, and maintaining a subscription to access digital services.

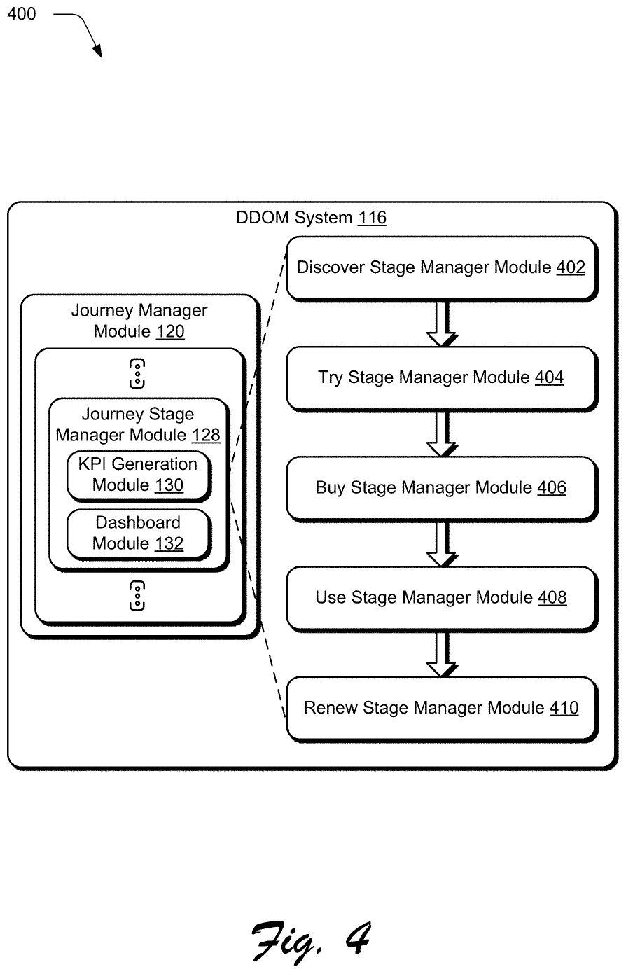

Accordingly, in the illustrated example 400 of FIG. 4, the journey manager module 120 implements a discover stage manager module 402, a try stage manager module 404, a buy stage manager module 406, a use stage manager module 408, and a renew stage manager module 410 using a respective journey stage manager module 128. In this way, the journey manager module 120 addresses the discover, try, buy, use, and renew stages 302-310 of FIG. 3 as part of matrixed implementation of the data lake 124.

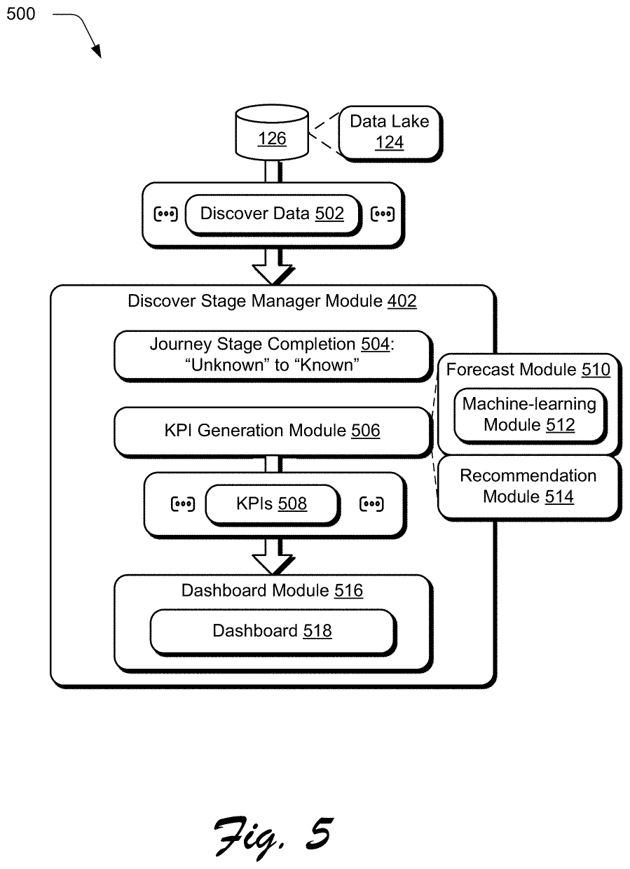

FIG. 5 depicts an example 500 of operation of the discover stage manager module 402 in greater detail. The discover stage 302 pertains to a portion of the data lake 124 of user IDs between exhibiting interest in the digital services and showing intent. This includes visits from user IDs as unqualified free members (UQFMs) that have signed up to access the digital services but have not done so, e.g., have not downloaded a desktop product. This also includes other user IDs that have exhibited interest such as lapsed traffic including user IDs that have subscribed but have cancelled within a threshold amount of time (e.g., 30 days), and stopped traffic including user IDs that have subscribed but have cancelled past the threshold amount of time (e.g., 30 days).

Journey stage completion 504 of the discover stage 302 as implemented by the discover stage manager module 402 is defined for when the user ID has migrated from “unknown” to “known,” e.g., has signed up to access the digital services including part of free signup. Thus, the discover stage 302 is defined for an interval of data from the data lake 124 between exhibiting interest to showing intent regarding the digital services in this example.

The discover stage manager module 402 also includes a KPI generation module 506 that is configured to generate KPIs 508 in real time as the discover data 502 is obtained. Examples of KPIs 508 supported by the discover stage manager module 402 includes “marketable universe” which is a total number of users that have expressed interest in the digital services and can be reached through one or more media channels, e.g., via cookie pools, an opt-in email database, and so forth. This measures a size of an opportunity of the service provider system 102 to communicate with current and potential customers of the digital services.

“Traffic” is a total number of unique visits to the service provider system, and may be defined to specify a magnitude and relative breakdown of the visits, e.g., free (“known” but current not yet paid customers), Put prospect (“unknown” users), lapsed (formerly paid users who cancelled more than 30 days ago), paid (currently paid customers), stopped (formerly paid users within 30 days of cancelling), etc. “Unqualified free members” (UQFMs) define a total number of visitors that have signed up for access but have not yet accessed the digital services (e.g., downloaded an application), and thus measures a size of a customer base that has shown an initial intent to sign-up for this access.

The KPI generation module 506 also includes a forecast module 510 having a machine-learning module 512 that is configured to generate KPIs 508 as forecasts of metrics. The machine-learning module 512, for instance, may include a model that is generated based on statistical methods (e.g., linear regression), use of neural networks, “deep learning,” and so forth to forecast KPIs 508 based on the discover data 502. In this way, the KPIs 508 may describe a “current view” in real time of operation of the digital services as well as predict future operation.

The KPI generation module 506 also includes a recommendation module 514 that is configured to form recommendations based on the KPIs 508. The recommendations, for instance, may identify a particular key performance indicator and its relationship to amounts targeted for the KPIs, such as by detecting that an amount for the particular key performance indicator deviates from the targeted amount. In this way, the recommendation module 514 may automatically “flag” particular KPIs 508 that fall outside desired targets.

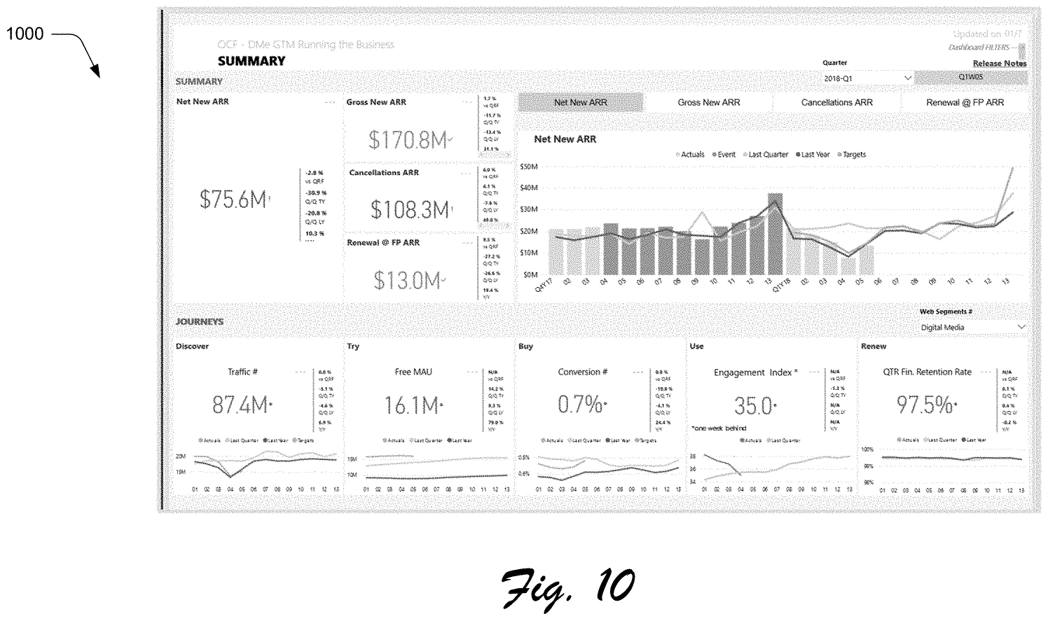

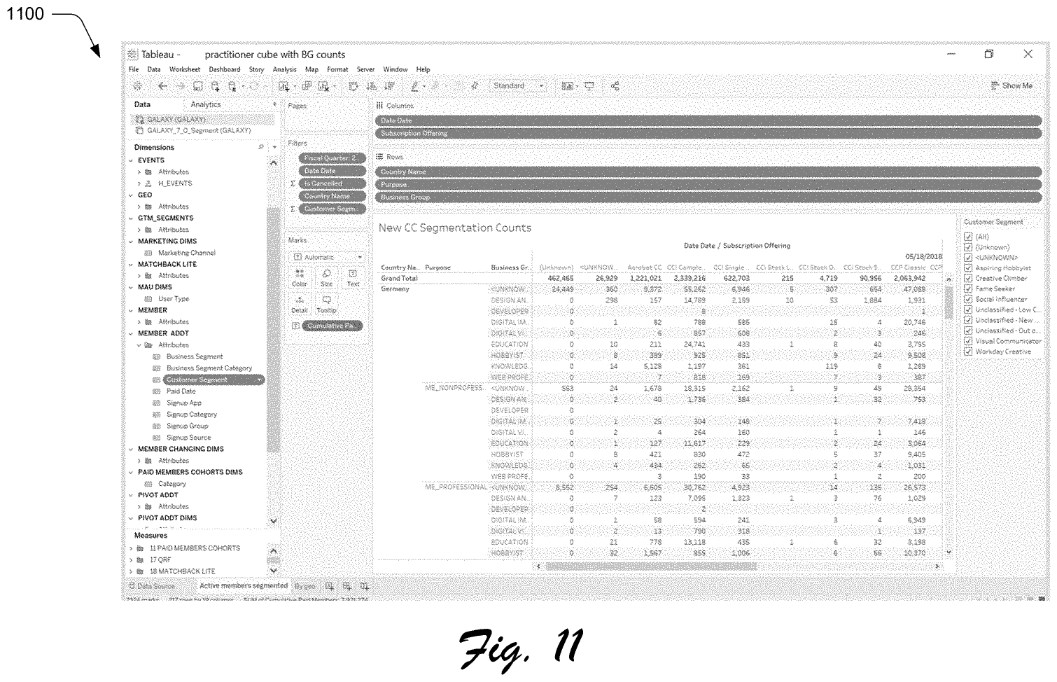

The KPIs 508 along with the forecasts and recommendations are then output to a dashboard module 516 for output via a dashboard 518. As previously described, the dashboard 518 is a user interface that supports real time output of the KPIs 508 to support insight into operation, management, and provisioning of the digital services. The dashboard 518 may be configured in a variety of ways, such as by particular personas as shown in an example 1000 of FIG. 10 as an “RTB” dashboard for executives and marketers, a “cube” dashboard for analysts and data scientists as shown in an example 1100 of FIG. 11, and so forth.

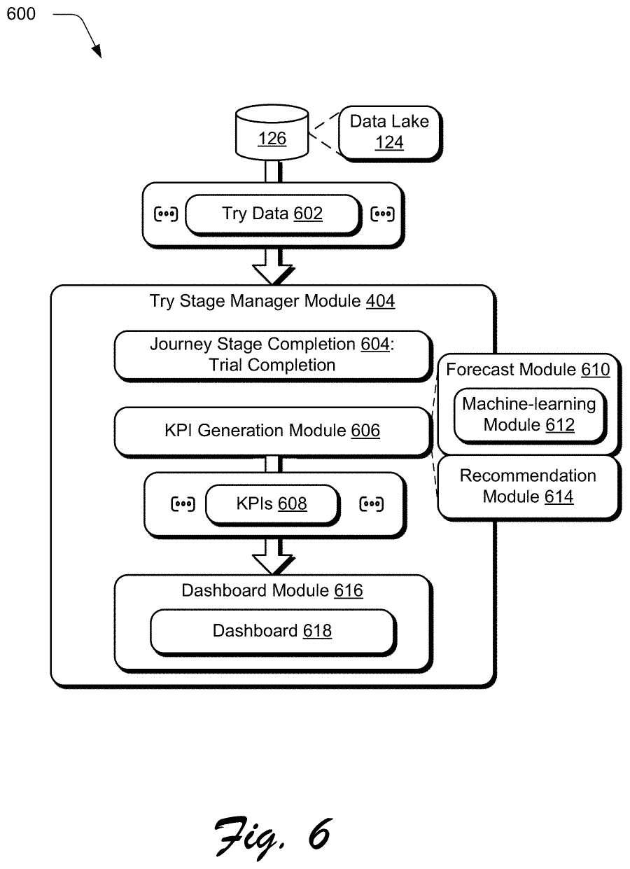

FIG. 6 depicts an example 600 of operation of the try stage manager module 404 in greater detail. The try stage 304 defines a portion of the data lake 124 as try data 602 obtained by the try stage manager module 404 having user IDs that have downloaded software as part of interaction with the digital services but are not currently paid subscribers. This includes user IDs that are within a finite trial time period that are entitled to access a digital service and other free user IDs in one example.

Thus, the try stage 304 implemented by the try stage manager module 404 describes an interval beginning as a qualified free member “QFM” as transitioning from the previous discover stage 302. Journey stage completion of the try stage 304 completes at the end of the trial, for instance, defined up to purchase of access to the digital service such as a subscription.

The try stage manager module 404 also includes a KPI generation module 606 to generate KPIs 608. This includes use of a forecast module 610 to generate the KPIs 608 using a machine-learning module 612 as forecast values of the KPIs. This also includes a recommendation module 614 to form recommendations based on values of the KPIs as described above.

Examples of KPIs 608 generated by the try stage manager module 404 includes “UQFMs to Qualified Free Member (QFM) Conversion”, which is a percentage of UQFMs that have initiated a process to access the digital services, e.g., downloaded free software locally such as the digital service modules 112 of FIG. 1. This measures customers who have moved from an initial intent (e.g., sign-up) to downloading a free product. In another example, “free user successful downloads” is used to indicate a percentage of QFMs that have initiated at least one download, which measures an ease of product setup. “Free user successful installs” is a percentage of QFMs that complete an instance, which also is a measure of the ease of product setup. “Free user successful launches” measures a percentage of QFMs that complete a first launch, which measures both an ease of product setup and initial interest.

Other examples are based on the UQFM and QFM base such as “Free User MAU” which measures the percentage of free users (UQFMs and QFMs) who have launched a product within a given month. This is a measure of free member engagement as before, the KPIs 608 are then output to the dashboard module 616 for display and rendering in a dashboard 618 in real time.

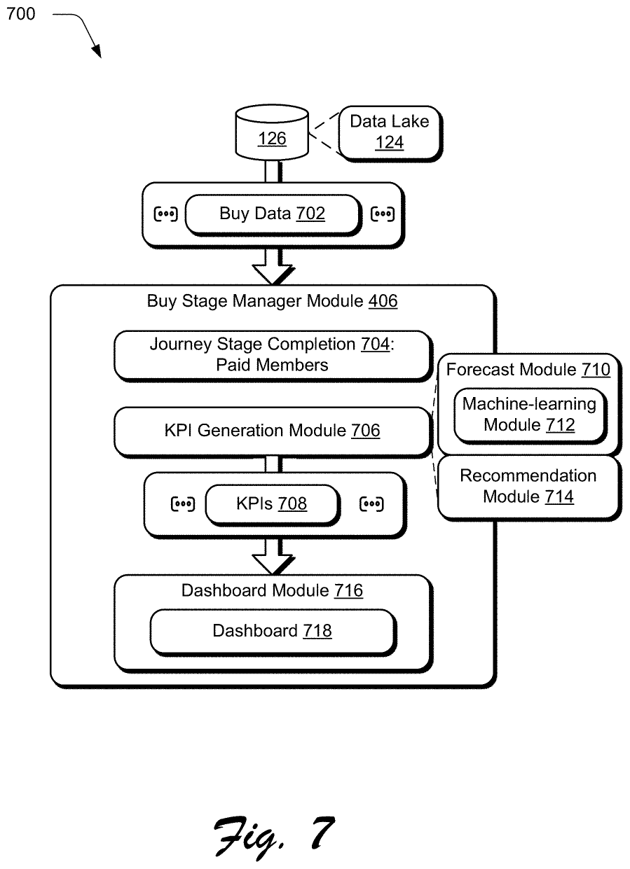

FIG. 7 depicts an example 700 of operation of the buy stage manager module 406 in greater detail. The buy stage 306 defines a portion of the data lake 124 describing user interaction of user IDs that are “converting” to pay for access to the digital services. Buy data 702 obtained by the buy stage manager module 406 thus describes “how” conversion is achieved for the user IDs in the data lake 124. This may include web conversion, such as direct to paid conversion, trial to paid conversion, lapsed to paid conversion, and paid to paid conversion. Phone conversion is also described including inbound and outbound conversion as well as conversion achieved by resellers. The buy stage 306 has a journey stage completion 704 defined based on reaching conversion as “paid members.”

As before, the buy stage manager module 406 includes a KPI generation module 706 to generate KPIs 708. This also includes use of a forecast module 710 to generate the KPIs 708 using a machine-learning module 712 as forecast values of the KPIs, as well as a recommendation module 714 to form recommendations based on values of the KPIs as described above.

Examples of the KPIs 708 include “web conversion” that measures a conversion rate from web visits and relative breakdown by channel, e.g., free, prospect, lapsed, and paid. “Marketing and source units” measures incremental impact of a marketing contribution through use of gross new units and annual recurring revenue forecasted to be received based on a customer's single action event attributed to paid media marketing channels. “Inbound phone conversion” and “outbound phone conversion” measure a percentage of inbound or outbound calls that convert to paid as a measure of effectiveness of these techniques. “Total gross new contracts” represents new business and growth of the book of business. Other examples include “average units per initial contract,” “annual recurring revenue per unit,” “add-on units per contract,” and “annual recurring revenue per add on units,” e.g., “seats.” The KPIs 708 are then output to the dashboard module 716 for display and rendering in a dashboard 718 in real time.

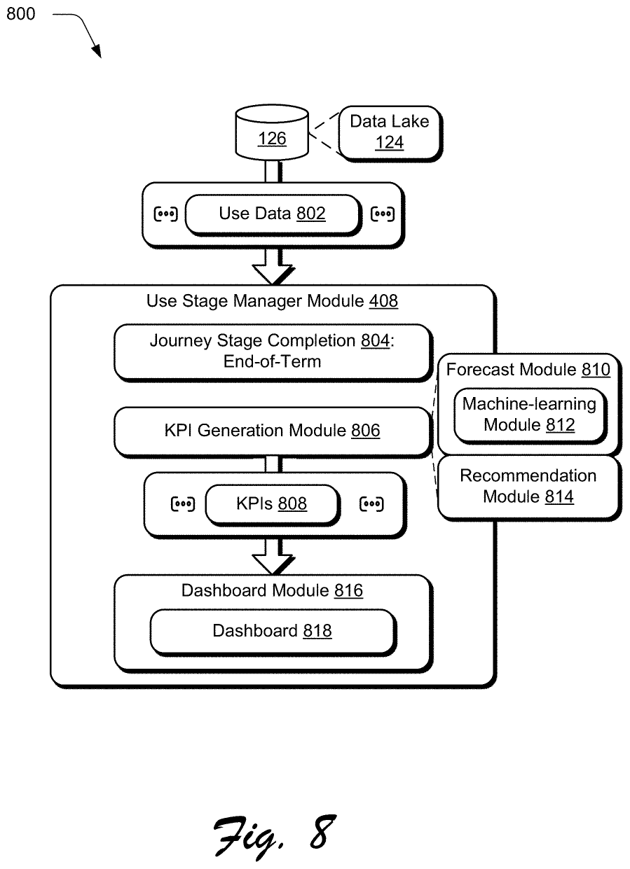

FIG. 8 depicts an example 800 of operation of the use stage manager module 408 in greater detail. The use stage 308 includes user IDs that currently pay for access to the digital services, e.g., are “converted” and thus describe “what happens” as part of user interaction with the digital services. This interval of the data lake 124 as described by the user data 802 includes what occurs after conversion and during use of the digital services, including set-up (e.g., download complete, install complete, launch complete) and use (e.g., return rate, engagement index). This stage has a journey stage completion 804 defined based on reaching an end of a term (e.g., subscription term) or has cancelled a right to gain access.

The use stage manager module 408 includes a KPI generation module 806 to generate KPIs 808. A forecast module 810 is included to generate the KPIs 808 using a machine-learning module 812 as forecast values of the KPIs, as well as a recommendation module 814 to form recommendations based on values of the KPIs. Examples of the KPIs 808 as generated by the use stage manager module 408 include “paid user successful downloads,” “paid user successful installs,” and “paid user successful launches” which measures of product setup and interest for paid users.

“Paid user return rate” for weeks one and four describes inflection points in which significant drop-offs are observed, behavior patterns are observed, and usage behavior patterns stabilize, respectively. Other examples include an engagement index which is a measurement rate for customer engagement, e.g., a number of times digital services are accessed over an amount of time, depth of engagement while in-product, and so on. The KPIs 808 are also output to the dashboard module 816 for display and rendering in a dashboard 818 in real time.

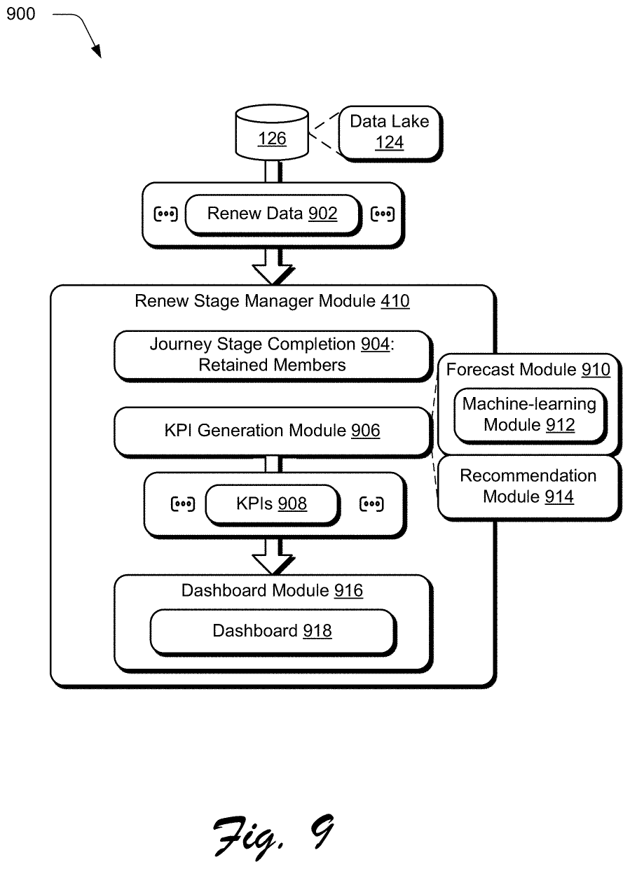

FIG. 9 depicts an example 900 of operation of the renew stage manager module 410 in greater detail. A renew stage 310 implemented by the renew stage manager module 410 follows the use stage 308 and pertains to a portion of the data lake 124 including user IDs that have renewed or cancelled, e.g., have cancelled paid-for access, have reached an end of term, and so forth. The renew stage 310 has a journey stage completion 904 defined as retained user IDs, e.g., user IDs that have transitioned back to one of the other journey stages such as discover, try, buy, or use stages 302-308.

Thus, KPIs 908 generated by the renew stage manager module 410 pertain to churn and retention rates. An “end of term retention rate” represents the percentage of seat renewals (baselined against number of active (paid) seats remaining at end of contract term).

Other examples include a “user initiated cancel rate” that measures a volume of customers that initiated cancellation but have not yet formally cancelled, a “save rate” that measures a volume of customers that initiated cancellation but were then retained, as well as a “net users cancel rate.” “Gross payment failure rate” measures a volume of customers who experience payment failure cancellation, “payment failure resolution rate” measures a volume of customers who experience payment failure cancellation that are retained, “payment failure rate,” and “financial retention rate”, measures a percentage of a quarter's beginning subscriptions and gross new subscriptions that were not cancelled during the quarter. The KPIs 908 are then output to the dashboard module 916 for display and rendering in a dashboard 918 in real time.

In this way, the journey manager module 120 implements a plurality of journey stage manager modules 128 that address respective stages as part of a user journey involving interaction with digital services implemented by the service provider system 102. As previously described, the journey may be described using a series of stages as sequential portions (which may be non-overlapping) of user engagement as part of obtaining and maintaining a subscription to access the digital services of the service provider system 102. Each of the stages, therefore, is an interval of data in a series of intervals between journey steps as part of getting, using, and maintaining a subscription to access digital services.

The DDOM system 116 also includes a segment manager module 122 that is configured to support output of user interfaces by a dashboard module 134 based on segments of portions of the data lake 124 across the stages of the journey. As shown in FIG. 3, for instance, segments may be defined based on user type (e.g., student segment 312), a surface by which the digital services are accessed (e.g., mobile segment 314), type of digital services used (e.g., photography segment 316), and so forth.

User segmentation describes a portion of a user population having shared characteristics. Other examples include a surface segment, e.g., mobile versus desktop devices. A mobile segment, for instance, may be defined for a segment of the data lake 124 that initiates contact with the digital services through use of free mobile applications and progresses to paid subscription across the journey stages.

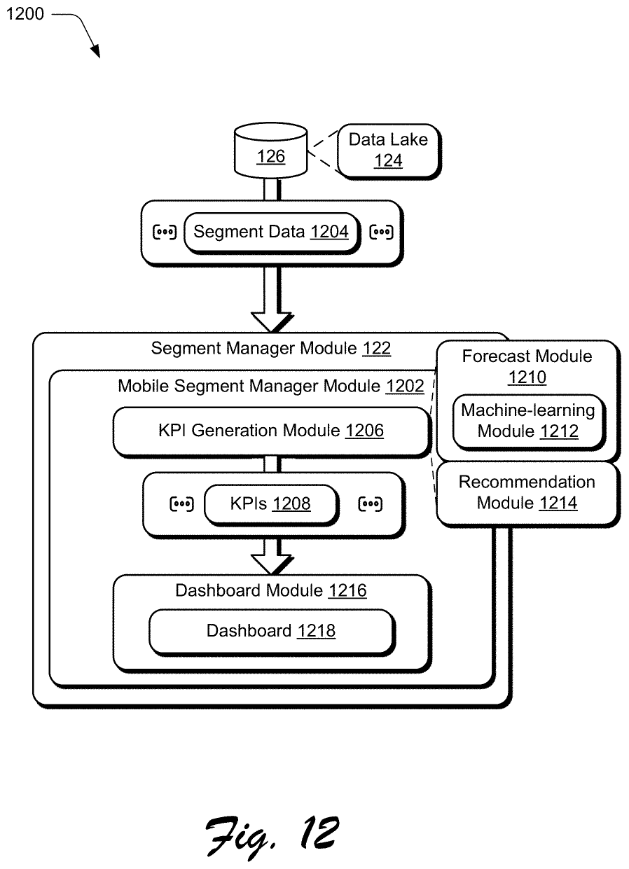

Therefore, like the journey manager module 120, the segment manager module 122 may implement modules that address particular segments in the data lake 124 across the journey stages, an example of which is illustrated in an example 1200 operation of FIG. 12 as a mobile segment manager module 1202. The mobile segment manager module 1202, like before, is configured to obtain segment data 1204 from the data lake 124 that corresponds to a mobile segment. The mobile segment manager module 1202, for instance, may output a user interface, via which, characteristics of the segment are defined. These characteristics are then used to obtain a portion of the data lake as segment data 1204 having those characteristics.

The segment manager module 122 may therefore support output of a user interface (i.e., dashboard) by the dashboard module 134 in real time as including KPIs generated by the KPI generation module 130 that describes a portion of the data lake 124 that corresponds to the mobile segment across the stages as a whole, at individual stages, and so on. The mobile segment is defined in this example as including user IDs that have initiated interaction with the digital services through use of mobile versions of the digital services, e.g., free versions of mobile applications.

The mobile segment manager module 1202 also includes a KPI generation module 1206 to generate KPIs 1208. A forecast module 1210 is included to generate the KPIs 1208 using a machine-learning module 1212 as forecast values of the KPIs, as well as a recommendation module 1214 to form recommendations based on values of the KPIs. Examples of the KPIs 1208 as generated by the use stage manager module 408 include KPIs 1208 generated for respective journey stages. The KPIs 1208, for instance, may include application (app) store impressions or number of visitors, app store download by source of traffic, market area, and so forth for the discover stage 302. KPIs 1208 for the renew stage 310 may include retention of mobile-sourced customers, mobile plans by product, platform, market area, and so on. The KPIs 1208 are then output to the dashboard module 1216 for display and rendering in a dashboard 1218 in real time. This may also support an ability to add comments, via the UI, regarding specific KPIs (e.g., as an overlay, bubble, and so forth) to support user collaboration across the stages and segments. The comments, for instance, may be entered for KPIs at particular stages/segments to share knowledge regarding insights obtained via those KPIs.

In this way, the journey manager module 120 and the segment manager module 122 support matrixed journey stage and segmentation of the data lake 124 to provide insights usable to manage implementation, access, and promotion of digital services by a service provider system. KPIs output by the user interfaces, for instance, may be used to provision computational and network resources of the service provider system to respond to user interaction with the digital services. The KPIs may also be used to provision resources involving communication of digital content and offers by the DDOM system 116 to the users, such as to communicate digital marketing content, free mobile applications, and so on.

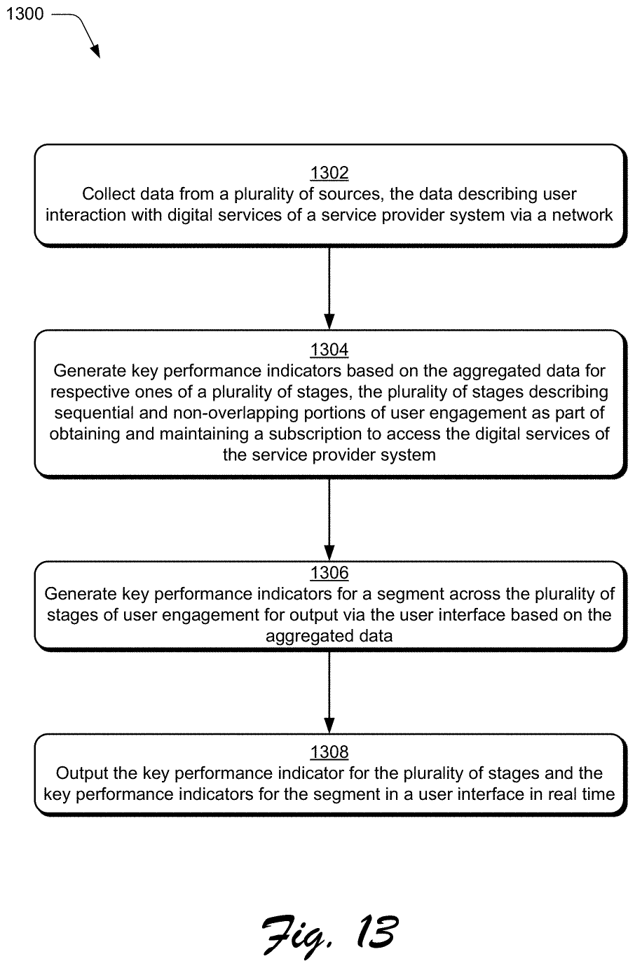

FIG. 13 depicts a procedure 1300 in an example implementation of operation of the DDOM system 116. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made to FIGS. 1-13.

Data is collected by a data aggregation module 118 in real time from a plurality of sources. The data describes user interaction with digital services of a service provider system via a network (block 1302). The data, for instance, may include user profile data 206, financial data 212, clickstream data 218, product data 224, entitlement data 230, and targeting data 236. The data may also be transformed using a data transformation module 240 and converted for consumption by a data consumption module 242 as shown in FIG. 3 to generate a data lake 124.

Key performance indicators are then generated by a KPI generation module 130 based on the aggregated data for respective ones of a plurality of stages. The plurality of stages describes sequential and non-overlapping portions of user engagement as part of obtaining and maintaining a subscription to access the digital services of the service provider system (block 1304). The stages, for instance, may include a discover stage 302, try stage 304, buy stage 306, use stage 308, and renew stage 310.

Key performance indicators are also generated by a KPI generation module 1206 of a segment manager module 122 for a segment across the plurality of stages of user engagement for output in real time via the user interface based on the aggregated data (block 1306). The key performance indicator for the plurality of stages and the key performance indicators for the segment are then output in a user interface in real time (block 1308), e.g., by dashboard modules 132, 134. In this way, petabytes of data from a diverse range of sources may be processed in real time to gain insights to manage operation of computing devices that implement the digital services, expose data describing user interaction with the services, forecast future user interaction, and generate recommendations regarding the user interaction.

### Example System and Device

FIG. 14 illustrates an example system generally at 1400 that includes an example computing device 1402 that is representative of one or more computing systems and/or devices that may implement the various techniques described herein. This is illustrated through inclusion of the DDOM system 116. The computing device 1402 may be, for example, a server of a service provider, a device associated with a client (e.g., a client device), an on-chip system, and/or any other suitable computing device or computing system.

The example computing device 1402 as illustrated includes a processing system 1404, one or more computer-readable media 1406, and one or more I/O interface 1408 that are communicatively coupled, one to another. Although not shown, the computing device 1402 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1404 is representative of functionality to perform one or more operations using hardware. Accordingly, the processing system 1404 is illustrated as including hardware element 1410 that may be configured as processors, functional blocks, and so forth. This may include implementation in hardware as an application specific integrated circuit or other logic device formed using one or more semiconductors. The hardware elements 1410 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1406 is illustrated as including memory/storage 1412. The memory/storage 1412 represents memory/storage capacity associated with one or more computer-readable media. The memory/storage component 1412 may include volatile media (such as random access memory (RAM)) and/or nonvolatile media (such as read only memory (ROM), Flash memory, optical disks, magnetic disks, and so forth). The memory/storage component 1412 may include fixed media (e.g., RAM, ROM, a fixed hard drive, and so on) as well as removable media (e.g., Flash memory, a removable hard drive, an optical disc, and so forth). The computer-readable media 1406 may be configured in a variety of other ways as further described below.

Input/output interface(s) 1408 are representative of functionality to allow a user to enter commands and information to computing device 1402, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1402 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1402. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1402, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1410 and computer-readable media 1406 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1410. The computing device 1402 may be configured to implement particular instructions and/or functions corresponding to the software and/or hardware modules. Accordingly, implementation of a module that is executable by the computing device 1402 as software may be achieved at least partially in hardware, e.g., through use of computer-readable storage media and/or hardware elements 1410 of the processing system 1404. The instructions and/or functions may be executable/operable by one or more articles of manufacture (for example, one or more computing devices 1402 and/or processing systems 1404) to implement techniques, modules, and examples described herein.

The techniques described herein may be supported by various configurations of the computing device 1402 and are not limited to the specific examples of the techniques described herein. This functionality may also be implemented all or in part through use of a distributed system, such as over a “cloud” 1414 via a platform 1416 as described below.

The cloud 1414 includes and/or is representative of a platform 1416 for resources 1418. The platform 1416 abstracts underlying functionality of hardware (e.g., servers) and software resources of the cloud 1414. The resources 1418 may include applications and/or data that can be utilized while computer processing is executed on servers that are remote from the computing device 1402. Resources 1418 can also include services provided over the Internet and/or through a subscriber network, such as a cellular or Wi-Fi network.

The platform 1416 may abstract resources and functions to connect the computing device 1402 with other computing devices. The platform 1416 may also serve to abstract scaling of resources to provide a corresponding level of scale to encountered demand for the resources 1418 that are implemented via the platform 1416. Accordingly, in an interconnected device embodiment, implementation of functionality described herein may be distributed throughout the system 1400. For example, the functionality may be implemented in part on the computing device 1402 as well as via the platform 1416 that abstracts the functionality of the cloud 1414.

### Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a data-driven operating model (DDOM) digital service management system, the system comprising:
a data aggregation module implemented by at least one computing device to aggregate data from a plurality of sources describing user interaction with digital services of a service provider system via a network;
a journey manager module implemented by the at least one computing device to generate:
key performance indicators based on the aggregated data for output via a user interface for respective ones of a plurality of stages of user engagement with the digital services; and
performance forecasts for output via the user interface for respective ones of a plurality of stages of user engagement with the digital services of the service provider system, the performance forecasts generated using machine learning in real time based on the aggregated data; and
a segment manager module implemented by the at least one computing device to generate key performance indicators for a segment of a user population across the plurality of stages of user engagement for output via the user interface.

2. The system as described in claim 1, wherein the plurality of stages are sequential stages that describe non-overlapping portions of user engagement as part of obtaining and maintaining a subscription to access the digital services.

3. The system as described in claim 1, wherein the plurality of sources includes user profile data, financial data, clickstream data, product data describing usage of the digital services, entitlement data, and targeting data.

4. The system as described in claim 1, wherein one or more stages of the plurality of stages includes an event indicating a transition from the one or more stages to another stage of the plurality of stages.

5. The system as described in claim 1, wherein the plurality of stages includes a discover stage, a try stage, a buy stage, a user stage, and a renew stage.

6. The system as described in claim 5, wherein at least one said key performance indicator for the discover stage includes:
free traffic indicating a number of user visits involving a free sign up and have not previously purchases a subscription;
paid traffic indicating user visits having paid entitlement, prospect traffic indicating user visits that have not signed up;
lapsed traffic indicating a number of users visits from users that were in paid entitlement but have cancelled within a threshold amount of time; or
stopped traffic including a number of user visits from users that were in paid entitlement and have not cancelled within the threshold amount of time.

7. The system as described in claim 5, wherein at least one said key performance indicator for the try stage includes:
trial users indicating a number of user visits within a trial time period for access to the digital services;
stopped users indicating a number of formerly paid users that are within a threshold amount of time of a paid entitlement that have not accessed the digital services;
lapsed users indicating a number of formerly paid users that are within a threshold amount of time of a paid entitlement that have not accessed the digital services; or
a number of successful downloads, installs, or launches.

8. The system as described in claim 5, wherein at least one said key performance indicator for the buy stage includes:
direct to paid conversion indicating a number of users that have purchased rights to access the digital services without use of a tree trial;
trial to paid conversion indicating a number of users that have purchased rights to access the digital services after a free trial;
lapsed to paid conversion indicating a number of users that have made a purchase involving the digital services after a threshold amount of time has passed; or
paid to paid conversion indicating a number of user purchases made by users that have paid to access the digital services.

9. The system as described in claim 5, wherein at least one said key performance indicator for the use stage includes return rate, seats assignment rate, seat launch rate, and a measure of an amount of time a respective user ID has continued to purchase rights to access the digital services.

10. The system as described in claim 5, wherein at least one said key performance indicator for the renew stage includes point-in-time retention, an end of term retention rate, an annual retention rate, overall retention, entity attrition, seat level attrition, churn score, initiated cancellations rate, save rate, gross payment failure rate, payment resolution rate, net payment failure rate, financial retention rate, or cohort retention rate.

11. The system as described in claim 1, wherein the data aggregation module is configured to verify accuracy of transformed data through comparison of the data an input and as transformed for aggregation as part of a data lake as a unified data architecture.

12. In a data-driven operating model (DDOM) digital service management system, a method implemented by at least one computing device, the method comprising:
collecting, by the at least one computing device, data from a plurality of sources, the data describing user interaction with digital services of a service provider system via a network;
generating, by the at least one computing device in real time, key performance indicators based on the aggregated data for respective ones of a plurality of stages, the plurality of stages describing sequential and non-overlapping portions of user engagement as part of obtaining and maintaining a subscription to access the digital services of the service provider system;
generating, by the at least one computing device, key performance indicators for a segment across the plurality of stages of user engagement for output via the user interface based on the aggregated data; and
outputting, by the at least one computing device, the key performance indicator for the plurality of stages and the key performance indicators for the segment in a user interface.

13. The system as described in claim 12, wherein the plurality of sources includes user profile data, financial data, clickstream data, product data describing usage of the digital services, entitlement data, and targeting data.

14. The system as described in claim 12, wherein the digital services implement digital content creation.

15. The system as described in claim 12, further comprising generating performance forecasts for output via the user interface for respective ones of a plurality of stages of user engagement with the digital services of the service provider system, the performance forecasts generated using machine learning in real time based on the aggregated data.

16. The system as described in claim 12, further comprising generating a recommendation identifying a particular key performance indicator of the key performance indicators.

17. The system as described in claim 16, wherein the recommendation is based on detecting that an amount for the particular key performance indicator deviates from a target amount for the particular key performance indicator.

18. In a data-driven operating model (DDOM) digital service management system, the method comprising:
means for collecting data in real time from a plurality of sources, the data describing user interaction with digital services of a service provider system via a network;
means for generating key performance indicators based on the aggregated data for respective ones of a plurality of stages, the plurality of stages describing sequential and non-overlapping portions of user engagement as part of obtaining and maintaining a subscription to access the digital services of the service provider system;
means for generating key performance indicators based on the aggregated data for a segment across the plurality of stages of user engagement for output in real time via the user interface; and
means for outputting in real time the key performance indicator for the plurality of stages, respectively, and the key performance indicators for the segment in a user interface across the plurality of stages.

19. The system as described in claim 18, further comprising means for generating performance forecasts for output via the user interface for respective ones of a plurality of stages of user engagement with the digital services of the service provider system, the performance forecasts generated using machine learning in real time based on the aggregated data.

20. The system as described in claim 18, further comprising means for generating a recommendation identifying a particular key performance indicator of the key performance indicators, the recommendation generating means including means for detecting that an amount for the particular key performance indicator deviates from a target amount for the particular key performance indicator.
